(19) United States
(12) Patent Application Publication
(10) Pub. No.: US 2026/0046892 A1
(43) Pub. Date: Feb. 12, 2026

(54) METHOD AND DEVICE FOR TRANSMITTING AND RECEIVING PUSCH IN WIRELESS COMMUNICATION SYSTEM

(71) Applicant: LG ELECTRONICS INC., Seoul (KR)

(72) Inventors: Seokmin SHIN, Seoul (KR); Suckchel YANG, Seoul (KR); Hyunsoo KO, Seoul (KR); Seonwook KIM, Seoul (KR)

(73) Assignee: LG ELECTRONICS INC., Seoul (KR)

(21) Appl. No.: 19/100,914

(22) PCT Filed: Jul. 17, 2023
(86) PCT No.: PCT/KR2023/010188

§ 371 Date: Feb. 3, 2025

(30) Foreign Application Priority Data
Aug. 5, 2022 (KR) 10-2022-0098170
Nov. 4, 2022 (KR) 10-2022-0146493
Feb. 16, 2023 (KR) 10-2023-0021051

(51) Int. Cl. H04W 72/232; H04W 72/0453; H04W 72/21

(52) U.S. Cl. CPC H04W 72/232; H04W 72/0453; H04W 72/21

(57) ABSTRACT

A method and a device for transmitting and receiving a PUSCH in a wireless communication system are disclosed. The method according to one embodiment of the present disclosure may comprise the steps of: receiving, from a base station, first configuration information related to a PUSCH, wherein the first configuration information includes first information about whether dynamic waveform switching for the PUSCH is supported; receiving, from the base station, a DCI scheduling the PUSCH; and transmitting the PUSCH to the base station.

### CROSS-REFERENCE TO RELATED APPLICATION(S)

This application is the National Stage filing under 35 U.S.C. 371 of International Application No. PCT/KR2023/010188, filed on Jul. 17, 2023, which claims the benefit of earlier filing date and right of priority to Korean Application Nos. 10-2022-0098170, filed on Aug. 5, 2022, 10-2022-0146493, filed on Nov. 4, 2022, and 10-2023-0021051, filed on Feb. 16, 2023, the contents of which are all incorporated by reference herein in their entirety.

### TECHNICAL FIELD

The present disclosure relates to a wireless communication system, and in more detail, relates to a method and an apparatus of transmitting and receiving a PUSCH (physical uplink shared channel) in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

A technical object of the present disclosure is to provide a method and an apparatus for dynamically switching/changing a waveform for configured grant (CG) PUSCH transmission and/or dynamic grant (DG) PUSCH transmission.

In addition, an additional technical object of the present disclosure is to provide a method and an apparatus for dynamically switching/changing a waveform for a plurality of PUSCH transmissions scheduled in multiple cells.

In addition, an additional technical object of the present disclosure is to provide a method and an apparatus for dynamically switching/changing a waveform in fallback DCI.

The technical objects to be achieved by the present disclosure are not limited to the above-described technical objects, and other technical objects which are not described herein will be clearly understood by those skilled in the pertinent art from the following description.

A method performed by a user equipment (UE) in a wireless communication system according to an aspect of the present disclosure may include: receiving first configuration information related to a physical uplink shared channel (PUSCH) from a base station, wherein the first configuration information includes first information on whether dynamic waveform switching for the PUSCH is supported; receiving downlink control information (DCI) scheduling the PUSCH from the base station; and transmitting the PUSCH to the base station. Based on that the dynamic waveform switching is supported, whether DCI includes second information indicating that transform precoding for the PUSCH is enabled or disabled may be determined based on a type of a search space in which the DCI is monitored.

A method performed by a base station in a wireless communication system according to another aspect of the present disclosure may include: transmitting first configuration information related to a physical uplink shared channel (PUSCH) to a user equipment (UE), wherein the first configuration information includes first information on whether dynamic waveform switching for the PUSCH is supported; transmitting downlink control information (DCI) scheduling the PUSCH to the UE; and receiving the PUSCH from the UE. Based on that the dynamic waveform switching is supported, whether DCI includes second information indicating that transform precoding for the PUSCH is enabled or disabled may be determined based on a type of a search space in which the DCI is monitored.

According to an embodiment of the present disclosure, by dynamically switching/changing a waveform for CG PUSCH transmission and/or DG PUSCH transmission, the performance for uplink transmission and reception can be improved.

In addition, according to an embodiment of the present disclosure, by independently switching/changing a waveform for each cell for a plurality of PUSCH transmissions scheduled in multiple cells, the performance for uplink transmission and reception can be improved.

In addition, according to an embodiment of the present disclosure, even if a waveform is dynamically switched/changed in fallback DCI, the impact on the existing operation can be minimized.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 is a diagram illustrating an uplink transmission and reception operation in a wireless communication system to which the present disclosure can be applied.

FIG. 8 is a diagram illustrating a signaling method for a PUSCH transmission and reception method according to an embodiment of the present disclosure.

FIG. 9 is a diagram illustrating an operation of a UE for a PUSCH transmission and reception method according to an embodiment of the present disclosure.

FIG. 10 is a diagram illustrating an operation of a base station for a PUSCH transmission and reception method according to an embodiment of the present disclosure.

FIG. 11 illustrates a block diagram of a wireless communication device according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS (Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR (New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN(New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information—reference signal resource indicator
CSI: channel state information
CSI-IM: channel state information—interference measurement
CSI-RS: channel state information—reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

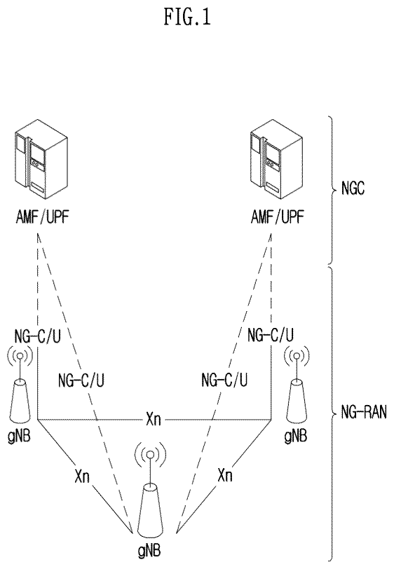

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC (Radio Link Control)/MAC/PHY) and UE. The gNBs are interconnected through a Xn interface. The gNB, in addition, is connected to an NGC (New Generation Core) through an NG interface. In more detail, the gNB is connected to an AMF (Access and Mobility Management Function) through an N2 interface, and is connected to a UPF (User Plane Function) through an N3 interface.

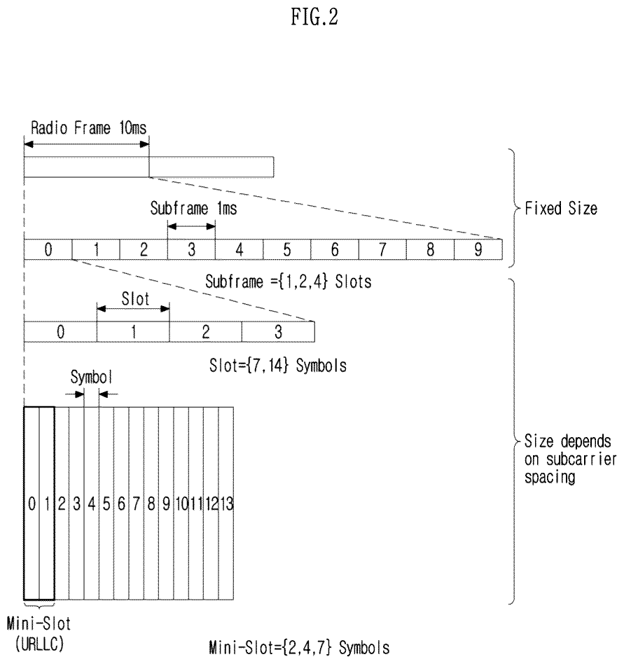

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, μ). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise.

An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480·103 Hz and N_{f} is 4096. Downlink and uplink transmission is configured (organized) with a radio frame having a duration of T_{f}=1/(ΔfₘₐₓN_{f}/100)·T_{c}=10 ms. Here, a radio frame is configured with 10 subframes having a duration of T_{sf}=(ΔfₘₐₓN_{f}/1000) T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration, slots are numbered in an increasing order of nₛ^{μ}∈{0, . . . , Nₛₗₒₜ^{subframe,μ}−1} in a subframe and are numbered in an increasing order of n_{s,f}^{μ}∈{0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used.

Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 2 is an example on μ=² (SCS is 60 kHz), 1 subframe may include 4 slots referring to Table 3. 1 subframe={1, 2, 4} slot shown in FIG. 2 is an example, the number of slots which may be included in 1 subframe is defined as in Table 3 or Table 4. In addition, a mini-slot may include 2, 4 or 7 symbols or more or less symbols.

Regarding a physical resource in a NR system, an antenna port, a resource grid, a resource element, a resource block, a carrier part, etc. may be considered. Hereinafter, the physical resources which may be considered in an NR system will be described in detail.

First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing.

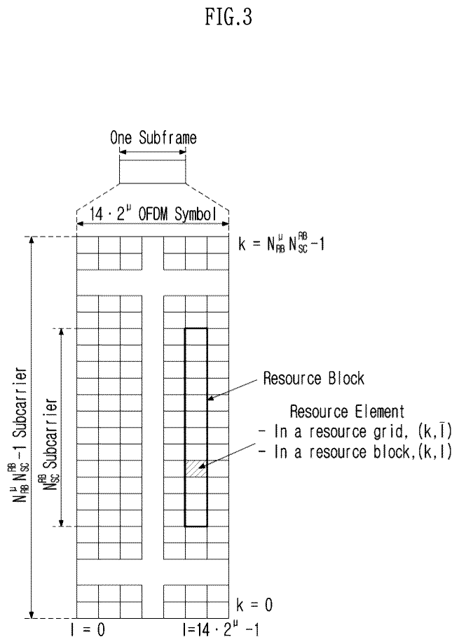

FIG. 3 illustrates a resource grid in a wireless communication system to which the present disclosure may be applied.

In reference to FIG. 3, it is illustratively described that a resource grid is configured with N_{RB}^{μ}N_{sc}^{RB} subcarriers in a frequency domain and one subframe is configured with 14·2^{μ} OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per and antenna port p. Each element of a resource grid for and an antenna port p is referred to as a resource element and is uniquely identified by an index pair (k,l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, l=0, . . . , N_{symb}−1. A resource element (k,l′) for and an antenna port p corresponds to a complex value, a_{k,l′}^{(p,μ)}. When there is no risk of confusion or when a specific antenna port or numerology is not specified, indexes p and may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k,l) for a subcarrier spacing configuration in a frequency domain is given as in the following Equation 1.

$${n}_{C R B}^{μ} = ⌊ \frac{k}{{N}_{s c}^{R B}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block nPRB and a common resource block n_{CRB} in BWP i is given by the following Equation 2.

$${n}_{C R B}^{μ} = {n}_{P R B}^{μ} + {N}_{B WP , i}^{s t art , μ} \qquad [ Equation 2 ]$$

N_{BWP,i}^{start,μ} is a common resource block that a BWP starts relatively to common resource block 0.

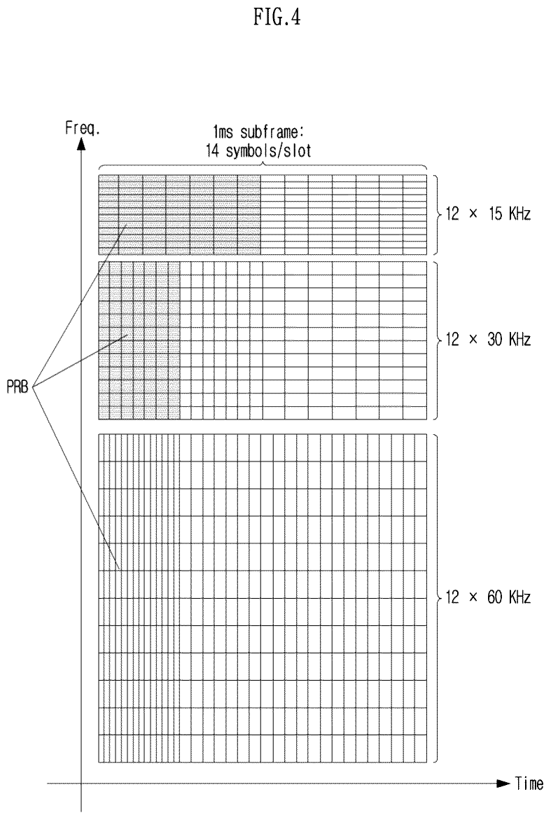

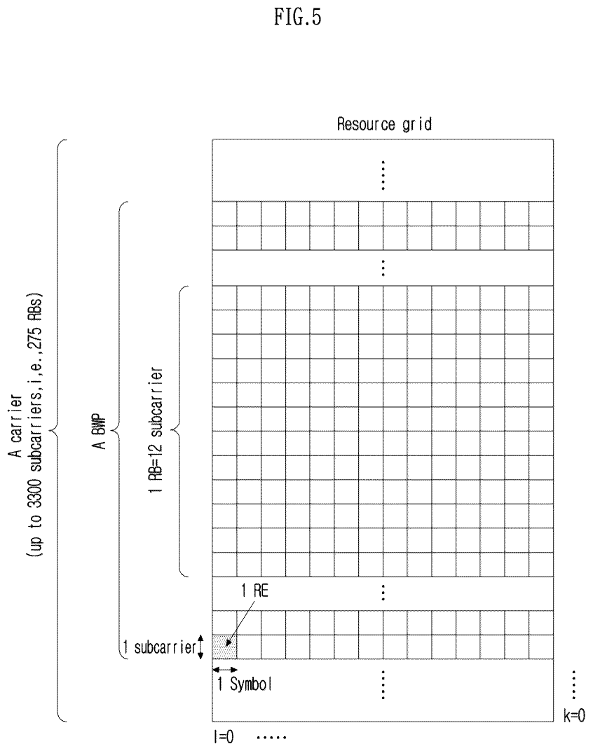

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

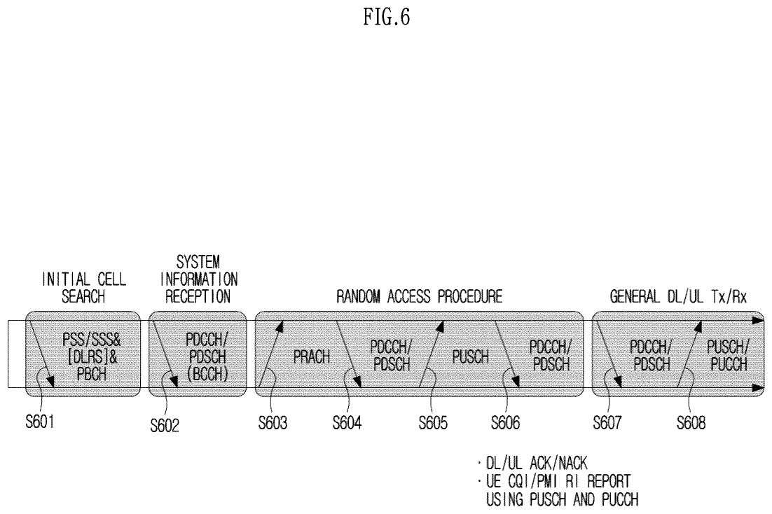

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI Format | Use |
|---|---|
| 0_0 | Scheduling of a PUSCH in one cell |
| 0_1 | Scheduling of one or multiple PUSCHs in one |
| | cell, or indication of cell group downlink |
| | feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid—Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined.

DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted.

DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted.

DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 10, 1_1 and 1_2 may include resource information (e.g., frequency resource allocation, time resource allocation, VRB (virtual resource block)-PRB (physical resource block) mapping, etc.), information related to a transport block (TB)(e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### Uplink Transmission and Reception Operation

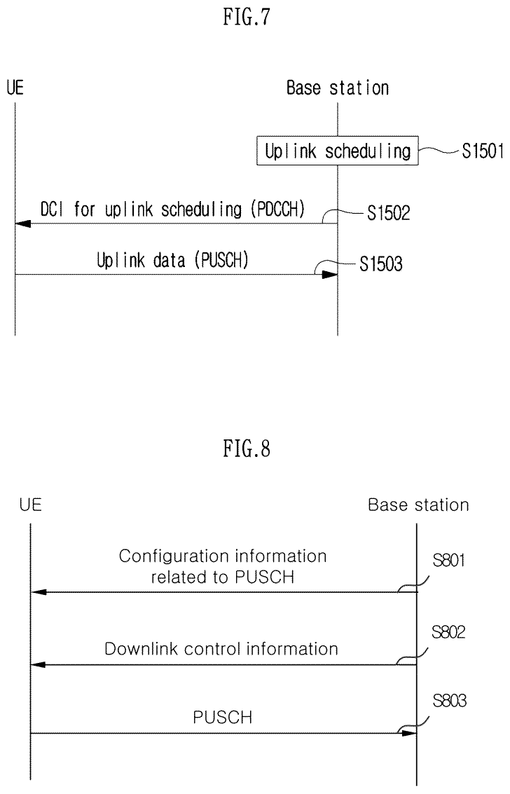

FIG. 7 is a diagram illustrating an uplink transmission and reception operation in a wireless communication system to which the present disclosure can be applied.

Referring to FIG. 7, a base station schedules uplink transmission such as a frequency/time resource, a transport layer, an uplink precoder, an MCS, etc. (S1501). In particular, a base station can determine a beam for PUSCH transmission to a UE through the operations described above.

A UE receives DCI for uplink scheduling (i.e., including scheduling information of a PUSCH) from a base station on a PDCCH (S1502).

DCI format 0_0, 01, or 0_2 may be used for uplink scheduling, and in particular, DCI format 0_1 includes the following information: an identifier for a DCI format, a UL/SUL (supplementary uplink) indicator, a bandwidth part indicator, a frequency domain resource assignment, a time domain resource assignment, a frequency hopping flag, a modulation and coding scheme (MCS), an SRS resource indicator (SRI), precoding information and number of layers, antenna port(s), an SRS request, a DMRS sequence initialization, a UL-SCH (Uplink Shared Channel) indicator

In particular, SRS resources configured in an SRS resource set associated with the higher upper layer parameter ‘usage’ may be indicated by an SRS resource indicator field. Additionally, the ‘spatialRelationInfo’ can be configured for each SRS resource, and its value can be one of {CRI, SSB, SRI}.

A UE transmits uplink data to a base station on a PUSCH (S1503).

When a UE detects a PDCCH including DCI formats 00, 01, and 0_2, it transmits a PUSCH according to indications by corresponding DCI.

Two transmission methods are supported for PUSCH transmission: codebook-based transmission and non-codebook-based transmission:

i) When the higher layer parameter ‘txConfig’ is set to ‘codebook’, a UE is configured to codebook-based transmission. On the other hand, when the higher layer parameter ‘txConfig’ is set to ‘nonCodebook’, a UE is configured to non-codebook based transmission. If the up higher per layer parameter ‘txConfig’ is not set, a UE does not expect to be scheduled by DCI format 0_1.

When a PUSCH is scheduled by DCI format 00, PUSCH transmission is based on a single antenna port.

For codebook-based transmission, a PUSCH may be scheduled in DCI format 00, DCI format 0_1, DCI format 0_2, or semi-statically. If this PUSCH is scheduled by DCI format 0_1, a UE determines a PUSCH transmission precoder based on an SRI, a TPMI (Transmit Precoding Matrix Indicator), and a transmission rank from DCI, as given by an SRS resource indicator field and a precoding information and number of layers field. A TPMI is used to indicate a precoder to be applied across antenna ports, and corresponds to an SRS resource selected by an SRI when multiple SRS resources are configured. Alternatively, if a single SRS resource is configured, a TPMI is used to indicate a precoder to be applied across antenna ports and corresponds to that single SRS resource. A transmission precoder is selected from an uplink codebook having the same number of antenna ports as the higher layer parameter ‘nrofSRS-Ports’. When a UE is configured with the higher layer parameter ‘txConfig’ set to ‘codebook’, the UE is configured with at least one SRS resource. An SRI indicated in slot n is associated with the most recent transmission of an SRS resource identified by the SRI, where the SRS resource precedes a PDCCH carrying the SRI (i.e., slot n).

ii) For non-codebook based transmission, a PUSCH may be scheduled in DCI format 0_0, DCI format 0_1, or semi-statically. When multiple SRS resources are configured, a UE can determine a PUSCH precoder and a transmission rank based on a wideband SRI, where, the SRI is given by an SRS resource indicator in DCI or by the higher layer parameter ‘srs-ResourceIndicator’. A UE uses one or multiple SRS resources for SRS transmission, where the number of SRS resources can be configured for simultaneous transmission within the same RB based on a UE capability. Only one SRS port is configured for each SRS resource. Only one SRS resource can be configured with the higher layer parameter ‘usage’ set to ‘nonCodebook’. The maximum number of SRS resources that can be configured for non-codebook based uplink transmission is 4. An SRI indicated in slot n is associated with the most recent transmission of an SRS resource identified by the SRI, where the SRS transmission precedes a PDCCH carrying the SRI (i.e., slot n).

### 1) Uplink Configured Grant

PUSCH configured grant is divided into CG (configured grant) Type 1 and CG Type 2.

In CG Type 1, resource allocation is completely configured or released using RRC signaling. When CG Type 1 is configured, a UE is allocated a resource set that can periodically transmit a PUSCH. A PDCCH is required only when retransmission is necessary. CG Type 1 PUSCH transmission is semi-statically configured to operate when receiving the higher layer parameter configuredGrantConfig including rrc-ConfiguredUplinkGrant without detection of a UL grant in DCI. A UE can perform PUSCH transmission according to the configured CG Type 1 until additional RRC signaling is reconfigured to the UE.

In CG Type 2, resource allocation is partially configured using RRC signaling, and activation/deactivation is indicated using PDCCH transmission. Since a PDCCH also provides time and frequency resource allocation, resource allocation may vary each time it is activated. CG Type 2 PUSCH transmission is scheduled semi-persistently by a UL grant in valid activation DCI after receipt of the higher layer parameter configuredGrantConfig that does not include rrc-ConfiguredUplinkGrant.

Although not shown in FIG. 7, higher layer signaling (RRC, etc.) for a PUSCH configured grant may be transmitted before lower layer signaling (DCI, etc.) for uplink scheduling.

One or more CG configurations of CG Type 1 and/or CG Type 2 may be activated simultaneously on an activated BWP of a serving cell.

In PUSCH transmission corresponding to CG Type 1 or CG Type 2, parameters for PUSCH transmission may be provided by configuredGrantConfig.

Table 6 shows an example of configuredGrantConfig IE. configuredGrantConfig IE is used to configure uplink transmission without dynamic grant by DCI. An actual uplink grant may be configured by RRC (CG Type 1) or provided through a PDCCH (by CS-RNTI) (CG Type 2). Multiple CG configurations can be configured within one BWP of a serving cell.

TABLE 6
-- ASN1START
-- TAG-CONFIGUREDGRANTCONFIG-START

| | |
|---|---|
| ConfiguredGrantConfig ::= | SEQUENCE { |
| frequencyHopping | ENUMERATED {intraSlot, interSlot} |

OPTIONAL, -- Need S

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, |

sym4x14, sym5x14, sym8x14, sym10x14, sym16x14, sym20x14,

sym32x14, sym40x14, sym64x14,

sym80x14, sym128x14, sym160x14, sym256x14, sym320x14, sym512x14,

sym640x14, sym1024x14, sym1280x14,

sym2560x14, sym5120x14,

sym6, sym1x12, sym2x12, sym4x12,

sym5x12, sym8x12, sym10x12, sym16x12, sym20x12, sym32x12,

sym40x12, sym64x12, sym80x12,

sym128x12, sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks−1) | OPTIONAL, -- Need R |
| pathlossReferenceIndex | INTEGER (0..maxNrofPUSCH- |

```
PathlossReferenceRSs−1),
    ...,
    [[
```

| | |
|---|---|
| pusch-RepTypeIndicator-r16 | ENUMERATED {pusch- |
| RepTypeA,pusch-RepTypeB} | OPTIONAL, -- Need M |

frequencyHoppingPUSCH-RepTypeB-r16 ENUMERATED {interRepetition,

| | |
|---|---|
| interSlot} | OPTIONAL, -- Cond RepTypeB |
| timeReferenceSFN-r16 | ENUMERATED {sfn512} |

```
OPTIONAL -- Need S
    ]]
  }
OPTIONAL, -- Need R
  ...,
```

In Table 6, the periodicity represents a period for uplink CG transmission, which means a time interval between consecutive continuous resource allocations. The periodicityExt is used to calculate a period of a uplink CG, and if this parameter does not exist, the periodicity is ignored. Values supported for an uplink CG period vary depending on the configured subcarrier spacing.

The nrofHARQ-Processes indicates a number of a HARQ process configured for an uplink CG. For dynamic resource allocation, a HARQ process identifier is specified within DCI associated with each resource allocation. However, in an uplink CG, an identifier of a HARQ process is determined based on a value of the nrofHARQ-Processes and a value of the periodicity.

The repK represents the number of repetitions. That is, it indicates a repetition level for each PUSCH transmission. The repK can have one of the following values: {1, 2, 4, 8}. For CG Type 1, if the pusch-RepTypeIndicator in rrc-ConfiguredUplinkGrant indicates ‘pusch-RepTypeB’, PUSCH repetition type B is applied, otherwise, PUSCH repetition type A is applied. In the case of CG Type 2, a PUSCH repetition type is determined by a UL grant of DCI. According to the configured PUSCH repetition type A or B, a UE transmits an uplink TB repeatedly as many times as the configured repetition number.

The repK-RV represents a redundancy version sequence. The repK-RV is configured when a repetition is used (i.e., repK is set to one of {2, 4, 8}).

The resourceAllocation indicates a configuration of bitmap-based resource allocation type 0 or resource indication value (RIV)-based resource allocation type 1.

The mcs-Table indicates an MCS table used by a UE for a PUSCH in which a transform precoding is not used, and the mcs-TableTransformPrecoder indicates an MCS table used by a UE for a PUSCH in which a transform precoding is used. The transformPrecoder indicates whether a transform precoding is enabled for a PUSCH.

The rrc-ConfiguredUplinkGrant is a configuration for CG Type 1 transmission. If this field does not exist, a UE uses an UL grant configured by DCI with a CS-RNTI (i.e., CG Type 2). The timeDomainAllocation indicates a start symbol and a length of a PUSCH and a PUSCH mapping type. The timeDomainOffset represents an offset related to a reference SFN (system frame number) indicated by the timeReferenceSFN. The timeReferenceSFN indicates an SFN used to determine an offset of a resource in a time domain. A UE uses an SFN closest to a number indicated before receiving a configured grant configuration, and if this field does not exist, a reference SFN is 0.

When a UE is scheduled to transmit a TB on a PUSCH by DCI, a ‘Time domain resource assignment’ field value of a UL grant in DCI provides a row value of a resource allocation table.

Each row of a resource allocation table defines parameters for time domain resource allocation, specifically, a slot offset (K_2) and a start and length indicator (SLIV) (or directly a starting symbol (S) and an allocation length (L)), a PUSCH mapping type, and a repetition number (when numberOfRepetitions is present) to be applied to PUSCH transmission are defined.

A resource allocation table may be configured by the higher layer parameter PUSCH-TimeDomainResourceAllocationList, or may be a predefined table.

The PUSCH-TimeDomainResourceAllocationList (i.e., resource allocation table) includes one or more PUSCH-TimeDomainResourceAllocation IEs. PUSCH-TimeDomainResourceAllocation IE is used to establish a time domain relationship between a PDCCH and a PUSCH, and configure parameters for the above-described time domain resource allocation. A ‘Time domain resource assignment’ field in DCI, a value of 0 indicates the first element (TimeDomainResourceAllocation) in the list (i.e., the first row of the resource allocation table), a value of 1 indicates the second element in the list, and so on.

A UE may be configured to transmit a PUSCH repeatedly. In this case, a UE repeatedly transmits the same uplink data/transport block (TB).

A PUSCH repetition transmission method can be divided into PUSCH repetition type A and PUSCH repetition type B.

When a UE is scheduled by DCI format 0_1 or DCI format 0_2, if a PUSCH repetition type (i.e., pusch-RepTypelndicatorDCI-0-1 or pusch-RepTypeIndicatorDCI-0-2) is set to PUSCH repetition Type B (i.e., ‘pusch-RepTypeB’), the UE applies the PUSCH repetition Type B procedure when determining time domain resource allocation.

Otherwise, a UE applies the PUSCH repetition Type A procedure when determining time domain resource allocation for a PUSCH scheduled by a PDCCH.

2) PUSCH repetition

### PUSCH Repetition Type A

PUSCH repetition type A transmission refers to a slot level PUSCH repetition in which the same uplink data (TB or CSI) is transmitted repeatedly in consecutive slots, including only one repetition in one slot.

In PUSCH repetition type A transmission, a start symbol S of a PUSCH relative to a start of a slot, and a consecutive symbols L counted from a symbol S allocated for a PUSCH, are determined from a start and length indicator (SLIV) of an indicated row of a resource allocation table.

If a repetition number configuration (i.e., numberOfRepetitions) exists in a resource allocation table, a repetition number K is determined by the repetition number configuration (i.e., numberOfRepetitions). Otherwise, a number of repetitions for an uplink TB (e.g., higher layer parameter pusch-AggregationFactor) may have one of {2, 4, 8} values. That is, the same TB can be transmitted in 2 consecutive slots, 4 slots, or 8 slots. There is one TB transmission (i.e., one TO) in each slot. If a number of repetitions is not configured (i.e., if there is no pusch-AggregationFactor), a UE applies a value of 1.

When a UE transmits a PUSCH scheduled by DCI, if the UE is configured with a repetition count >1 (e.g., pusch-AggregationFactor >1), the same symbol allocation is applied across consecutive slots according to the configured number of repetitions. That is, a UE repeatedly transmits an uplink TB in the same symbol over several consecutive slots according to the configured repetition number. When repetitive transmission is configured, a PUSCH is limited to a single transmission layer.

For PUSCH repetition type A, intra-slot frequency hopping or inter-slot frequency hopping can be configured. In the case of inter-slot frequency hopping, frequency hopping occurs at a slot boundary. In the case of intra-slot frequency hopping, the number of symbols in the first hop and the number of symbols in the second hop are configured by the base station, and frequency hopping is performed at the configured symbol boundary.

### PUSCH Repeat Type B

PUSCH repetition type B transmission refers to a symbol level PUSCH repetition in which the same uplink data (TB or CSI) is repeatedly transmitted, including two or more repetitions in one slot.

In PUSCH repetitive type B transmission, a start symbol S of a PUSCH relative to a start of a slot, and a consecutive symbols L counted from a symbol S allocated for a PUSCH are respectively determined by a start symbol (i.e., startSymbol) and length (i.e., length) of an indicated row of a resource allocation table.

A nominal repetition number of PUSCH repetition type B is given by a repetition number configuration (i.e., numberOfRepetitions) in a resource allocation table. And, a start slot, a start symbol, an end slot, and an end symbol of the n-th nominal repetition (n=0, . . . , numberOfRepetitions-1) are determined based on a slot offset (K_2), an S value, and an L value to be applied to PUSCH transmission, respectively.

Here, a nominal number of repetitions means a number of repetitions indicated by RRC signaling, etc. For example, if one nominal repetition passes (including) a slot boundary (or DL/UL switching point), the one nominal repetition may be divided into two before and after the slot boundary (or DL/UL switching point), therefore an actual number of repetitions may be greater than the nominal number of repetitions.

A UE determines invalid symbol(s) for PUSCH repetition type B transmission based on predetermined methods. After determining invalid symbol(s) for PUSCH repetition Type B transmission for each nominal repetition, the remaining symbols are considered as potential valid symbol(s) for PUSCH repetition Type B transmission. If the number of potentially valid symbols for PUSCH repetition type B transmission for one nominal repetition is greater than 0, the nominal repetition includes one or more actual repetitions. Here, each actual repetition includes a contiguous set of all potentially valid symbols that can be used for PUSCH repetition type B within the slot. Except in the case of L=1, actual repetition for a single symbol is omitted, and actual repetition may be omitted under predetermined conditions.

For PUSCH repetition type B, inter-repetition frequency hopping or inter-slot frequency hopping can be configured. In the case of inter-repetition frequency hopping, frequency hopping is applied per nominal number of repetitions. In the case of inter-slot frequency hopping, frequency hopping occurs at a slot boundary.

### Dynamic Waveform Switching Method

The contents described above (NR frame structure, NTN system, etc.) can be applied in combination with the methods proposed in the present disclosure described below, or can be supplemented to clarify the technical features of the methods proposed in the present disclosure.

In addition, the methods described below are related to uplink transmission, and can be equally applied to the downlink signal transmission method in the NR system or LTE system described above. The technical feature proposed in the present disclosure can be appropriately modified or replaced with terms, expressions, structures, etc. defined in each system so that it can be implemented in the corresponding system,

NR supports multiple numerologies (or subcarrier spacing (SCS)) to support various 5G services. For example, when the SCS is 15 kHz, it supports a wide area in traditional cellular bands. When the SCS is 30 kHz/60 kHz, it supports dense-urban, lower latency, and wider carrier bandwidth. When the SCS is 60 kHz or higher, it supports a bandwidth greater than 24.25 GHz to overcome phase noise.

The NR frequency band is defined by two types of frequency ranges (FR1, FR2). FR1 and FR2 can be configured as shown in Table 7 below. In addition, FR2 can mean millimeter wave (mmW).

TABLE 7

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Currently, in NR, it is defined that a base station configures/indicates which waveform to use among cyclic prefix OFDM (CP-OFDM) and discrete Fourier transform spread OFDM (DFT-S-OFDM) through RRC signaling (e.g., system information block 1 (SIB1), UE-specific RRC signaling, etc.).

DFT-S-OFDM can be generated by combining transform precoding and CP-OFDM. Transform precoding reduces the relatively high peak to average power (PAPR) associated with CP-OFDM. Hereinafter, in the present disclosure, configuring/indicating DFT-S-OFDM can be interpreted as configuring/indicating that transform precoding is enabled, whereas configuring/indicating CP-OFDM can be interpreted as configuring/indicating that transform precoding is disabled.

To explain in more detail what is defined in 3GPP TS 38.331, in the case of a 4-step RACH procedure (i.e., a random access procedure), if the higher layer parameter/field “msg3-transformPrecoder” is indicated as enable in the RACH common configuration (RACH-ConfigCommon), DFT-S-OFDM is defined to be used as the UL waveform of Msg. 3 PUSCH. On the other hand, if the higher layer parameter/field “msg3-transformPrecoder” is absent, CP-OFDM is defined to be used as the UL waveform of Msg. 3 PUSCH. On the other hand, in the case of a 2-step RACH procedure, if the higher layer parameter/field “msgA-TransformPrecoder” is indicated as enable in the Msg. A PUSCH configuration (MsgA-PUSCH-Config), DFT-S-OFDM is defined to be used as the waveform of Msg. A PUSCH. On the other hand, if the higher layer parameter/field “msgA-TransformPrecoder” is indicated as disable, CP-OFDM is defined to be used as the waveform of Msg. A PUSCH.

Finally, if the higher layer parameter/field “transformPrecoder” is indicated as enable in the PUSCH configuration (PUSCH-Config) or the configured grant configuration (ConfiguredGrantConfig), DFT-S-OFDM is defined to be used as the waveforms of other UL channels (e.g., general PUSCH (i.e., PUSCH except configured grant (CG) PUSCH, configured PUSCH, etc.) except for the Msg. 3 PUSCH and Msg. A PUSCH, and if the higher layer parameter/field “transformPrecoder” is indicated as disable, CP-OFDM is defined to be used as the waveforms of other UL channels except for the Msg. 3 PUSCH and Msg. A PUSCH. In addition, if the “transformPrecoder” parameter/field is not separately indicated, it is defined to follow the configuration of “msg3-transformPrecoder”.

Meanwhile, when a dynamic waveform switching method is introduced, it is necessary to define how to configure the waveform (i.e., whether transform precoding is applied/activated) according to dynamic waveform switching according to a PUSCH type (e.g., dynamic grant (DG) PUSCH, configured grant (CG) PUSCH). Therefore, in this disclosure, when dynamic waveform switching is introduced, we propose a configuration method in a UE and/or a base station when considering different PUSCH types.

### Embodiment 1: Method for Configuring Dynamic Waveform Switching According to PUSCH Type

The PUSCH types currently introduced in NR are a general PUSCH (i.e., dynamic grant (DG) PUSCH) and a configured grant (CG) PUSCH. The DG PUSCH refers to a PUSCH scheduled by a base station using dynamic grant, for example, a PUSCH scheduled with UL grant such as DCI format 0_0, 0_1, 0_2, etc. The CG PUSCH is a method in which a UE transmits a PUSCH using time and frequency resources defined in advance by a base station, and is classified into type 1 CG PUSCH and type 2 CG PUSCH. Type 1 CG PUSCH is a method in which a PUSCH is transmitted according to a configured time/period (without activation DCI) after receiving RRC signaling from a base station. Type 2 CG PUSCH is a method of receiving RRC signaling from a base station, and then receiving activation DCI once more, and then transmitting PUSCH according to the time/period set through the RRC signaling.

### Method 1: Method for Applying Dynamic Waveform Switching Configuration for DG PUSCH to CG PUSCH

When a UE is in an RRC connected state/mode, if a base station configures/indicates a waveform (i.e., transform precoding enabled/disabled) according to dynamic waveform switching through DCI for scheduling a DG PUSCH, the UE can transmit the PUSCH scheduled by the DCI using the configured/indicated waveform (i.e., transform precoding applied/disabled). Here, if a specific CG PUSCH transmission resource is configured in advance by RRC signaling and a waveform of a DG PUSCH is dynamically changed through DCI for scheduling the DG PUSCH before the CG PUSCH transmission time, it is necessary to define how the waveform of the specific CG PUSCH is determined.

For example, in the first method, regardless of a dynamic waveform switching configuration/indication of a DG PUSCH (i.e., dynamic waveform indication according to dynamic waveform switching), a CG PUSCH can be configured to always follow (apply) a waveform configured/indicated through higher layer signaling (i.e., SIB, UE specific RRC signaling, etc.). However, using this method, although a base station can dynamically change a waveform of a DG PUSCH, it is difficult to dynamically change a waveform because in order to change a waveform of CG PUSCH, the existing method of re-configuring/transmitting SIB or transmitting UE specific RRC signaling must be performed.

Here, a method of using activation DCI for dynamic waveform switching can be considered, specifically, for type 2 CG PUSCH. That is, in a DCI (field) configuration meaning the activation, dynamic waveform switching can be configured/indicated along with the activation of type 2 CG PUSCH by indicating a specific value defined in advance as a separate field value for dynamic waveform indication (i.e., using an existing defined field, but dynamically indicating a waveform of type 2 CG PUSCH according to a specific field value). Alternatively, a 1-bit field may be added to the corresponding activation DCI to configure/indicate dynamic waveform switching (i.e., dynamically indication a waveform of type 2 CG PUSCH). Here, the specific field value or the newly defined 1-bit field can explicitly configure/indicate a waveform to be actually applied to a CG PUSCH, or can be configured/indicated to change a waveform configured through the existing higher layer signaling (e.g., i) change it to disabled if the transform precoding is configured to enabled by the higher layer signaling, or ii) change it to enabled if the transform precoding is configured to disabled by the higher layer signaling).

For example, as a second method, even if a waveform of a CG PUSCH has been configured/indicated in advance through higher layer signaling (i.e., SIB, UE specific RRC signaling, etc.), if a base station configures/indicates dynamic waveform switching for a DG PUSCH between a time at which the configuration was performed and a time at which an actual CG PUSCH is transmitted (i.e., if a waveform for a DG PUSCH is indicated through DCI, etc.), a UE can ignore the waveform configured through the existing higher layer signaling for the waveform of the CG PUSCH and follow (apply) the waveform of the (most recently configured/indicated) DG PUSCH.

For example, another way is that a new parameter can be introduced in higher layer signaling (i.e., SIB, UE specific RRC signaling, etc.) for a CG PUSCH to configure/indicate whether dynamic waveform switching is allowed or not. That is, if the new parameter allows/supports dynamic waveform switching (i.e., configure/indicates as enable), it can be defined that the second method described above (i.e., a UE configures a waveform of a CG PUSCH to follow a waveform of (the most recently configured/indicated) a DG PUSCH while ignoring a waveform configured through the existing higher layer signaling) is used. If the new parameter does not allow/support dynamic waveform switching (i.e., configure/indicate to disable), it can be defined that the first method described above (i.e., a CG PUSCH is configured to always follow (apply) a waveform configured/indicated via higher layer signaling (i.e., SIB, UE specific RRC signaling, etc.) regardless of a dynamic waveform switching configuration/indication of a DG PUSCH) is used.

Meanwhile, a new parameter is introduced to configure/indicate whether dynamic waveform switching of a CG PUSCH is allowed/supported as in the proposed method, and if dynamic waveform switching of a CG PUSCH is allowed/supported through the parameter, a UE must be provided with additional parameter(s) required for each waveform in order to transmit the CG PUSCH with different waveforms (through dynamic indication). In other words, according to the existing method, a CG PUSCH is transmitted using a waveform configured by higher layer signaling and is not dynamically changed, so it was sufficient to provide only parameter(s) for the configured waveform in higher layer signaling. However, if dynamic waveform switching of a CG PUSCH is allowed/supported, a UE needs to be provided with additional parameter(s) required for each waveform in order to transmit the CG PUSCH using a changed waveform. Therefore, if a base station allows/supports dynamic waveform switching of a CG PUSCH, the base station can also provide a UE with additional parameter(s) required for each waveform through higher layer parameters/signaling.

For example, if a waveform of a CG PUSCH is semi-statically configured to waveform A (e.g., CP-OFDM) through the existing provided parameters, and dynamic waveform switching of the CG PUSCH is allowed/supported through the newly introduced parameters, a base station may provide a UE with additional parameter(s) corresponding to waveform B (e.g., DFT-S-OFDM). As a result, appropriate parameter(s) may be provided for each CG PUSCH configuration so that a UE can transmit using different waveforms (i.e., dynamically indicated waveforms). Here, the additional parameter may correspond to one or more parameters included in the higher layer parameter “ConfiguredGrantConfig” of TS 38.331. If the corresponding parameter(s) are not additionally indicated other than values provided for a waveform of the existing CG PUSCH, a UE may reuse the values provided for the waveform of the existing CG PUSCH when transmitting a CG PUSCH using a changed waveform (i.e., a dynamically indicated waveform). Here, it may be desirable to additionally provide the corresponding additional parameter for dynamic waveform switching of a specific CG PUSCH, separately from multiple CG PUSCH configurations initially configured by a base station.

In addition, a CG PUSCH that is semi-statically configured with the same waveform as a DG PUSCH configured/indicated at a specific time can be defined/configured to transmit a CG PUSCH according to the existing semi-static configuration. A CG PUSCH that is semi-statically configured with a different waveform from a DG PUSCH configured/indicated at a specific time is defined/configured to transmit a CG PUSCH by changing a waveform to the same waveform as the DG PUSCH, and in this case, the above-mentioned additional parameter(s) can be used.

However, if additional parameter(s) are configured as above, it is the same as providing the necessary parameters for each waveform as a double set (e.g., a set of parameter(s) for a waveform to which transform precoding is not applied and a set of parameter(s) for a waveform to which transform precoding is applied) for all CG PUSCHs (i.e., for all CG configurations), therefore signaling overhead of a base station may occur. Therefore, in another way, it is assumed that a base station is pre-configured to use different waveforms for multiple CG PUSCH configurations (i.e., both waveforms are configured to be available for each CG PUSCH configuration). In this case, if a waveform of a specific CG PUSCH is different from a waveform of a DG PUSCH transmitted (or indicated to be transmitted) immediately before, a parameter may be introduced that configures/indicates a UE not to transmit the CG PUSCH. If a UE may be configured/indicated not to transmit the CG PUSCH via the parameter when a waveform of a specific CG PUSCH is different from a waveform of a DG PUSCH transmitted (or instructed to be transmitted) immediately before, and if the waveform of the CG PUSCH is different from the waveform of the most recently transmitted (or indicated to be transmitted) DG PUSCH at a time of transmission of the specific CG PUSCH, the UE may drop/postpone the CG PUSCH without transmitting it. Here, if the CG PUSCH is defined not to be transmitted, a base station may be configured/defined to schedule a new DG PUSCH for a UE, and the UE may also expect that a new DG PUSCH will be scheduled instead of transmitting the existing CG PUSCH from the base station. Conversely, if the parameter is not transmitted or if the parameter is configured/indicated that a UE may transmit all CG PUSCHs regardless of a waveform of a DG PUSCH that was immediately transmitted (or indicated to be transmitted), the UE may be defined/configured to transmit a CG PUSCH at a time of a specific CG PUSCH transmission as in the existing operation.

Additionally, only a waveform of a CG PSUCH that is configured to be transmitted within a specific time interval (e.g., N ms, N slots, N OFDM symbols, etc.) from a time when a waveform of a DG PUSCH is dynamically changed or a time when a DG PUSCH is transmitted using a changed waveform may be configured/defined to change according to a waveform of a DG PUSCH that was configured/transmitted immediately before. Here, values for the specific time interval (e.g., N ms, N slots, N OFDM symbols, etc.) may be defined in advance, or a base station may configure/indicate a UE (or cell-specifically) through higher layer signaling, etc. If configured as such, if a waveform of a CG PUSCH set to be transmitted within a specific time interval from a time when a waveform of a DG PUSCH is changed or a time when a DG PUSCH is transmitted using a changed waveform is different from a waveform of a DG PUSCH configured/transmitted immediately before, a UE can change the waveform of the CG PUSCH to the waveform of the DG PUSCH and transmit it. Alternatively, if a waveform of a CG PUSCH configured to be transmitted within the specific time interval is different from a waveform of a DG PUSCH configured/transmitted immediately before, transmission of the corresponding CG PUSCH can be configured to be dropped/postponed. On the other hand, if a waveform of a CG PUSCH configured to be transmitted within the specific time interval is the same as a waveform of a DG PUSCH configured/transmitted immediately before, a UE can be configured to transmit the CG PUSCH using a waveform configured semi-statically without changing the waveform.

The proposed methods described above in this disclosure are mainly described for the case of application to type 1 CG PUSCH, but can also be configured/applied to type 2 CG PUSCH.

### Method 2: Method of Applying Dynamic Waveform Switching Configuration for CG PUSCH to DG PUSCH

In a method that can be commonly applied to type 1 CG PUSCH and/or type 2 CG PUSCH, a waveform can be independently configured (e.g., identically or differently) for each CG PUSCH configuration (i.e., for each CG PUSCH configuration index) (in the RRC configuration). A UE can transmit a CG PUSCH using a waveform defined in the corresponding RRC configuration, and the UE can transmit the CG PUSCH using the configured waveform until the waveform defined in the RRC configuration is changed by a base station (i.e., until a base station indicates a new waveform).

Meanwhile, since type 1 CG PUSCH does not have a separate activation DCI and only type 2 CG PUSCH has activation DCI, a method of configuring/indicating dynamic waveform switching (i.e., dynamically indicating waveform according to dynamic waveform switching) through the DCI that activates type 2 CG PUSCH can also be considered. Here, in a situation where a UE is in an RRC connected state/mode, if a base station configures/indicates dynamic waveform switching (i.e., dynamically indicating waveform according to dynamic waveform switching) through the DCI that activates type 2 CG PUSCH, a UE can change a waveform and transmit it when transmitting the type 2 CG PUSCH. After that, the UE can perform the CG PUSCH transmission by applying the indicated waveform (i.e., a waveform indicated by activation DCI when the waveform is indicated by the activation DCI, or a waveform configured by a CG PUSCH configuration when the waveform is not indicated by activation DCI) until it receives release DCI for the corresponding CG. However, if a DG PUSCH is scheduled from a base station during the transmission of type 2 CG PUSCHs for which dynamic waveform switching is configured/indicated in the above method, it is necessary to define what the waveform of the corresponding DG PUSCH will be.

In the first method, regardless of a dynamic waveform switching configuration/indication of type 2 CG PUSCH, a UE can always follow (apply) a waveform configured/indicated via higher layer signaling (i.e., SIB, UE specific RRC signaling, etc.) for DG PUSCH transmission. Alternatively, a dynamic waveform switching operation can be defined to be possible only through the DCI that schedules the corresponding DG PUSCH (i.e., dynamically indicating a waveform according to dynamic waveform switching). In other words, a method can be considered to configure/indicate dynamic waveform switching (i.e., dynamically indicating a waveform according to dynamic waveform switching) using independent DL signals/channels for each PUSCH type (e.g., for each DG PUSCH and (type 2) CG PUSCH).

In the second method, even if a waveform of a DG PUSCH has been previously configured/indicated through higher layer signaling (i.e., SIB, UE specific RRC signaling, etc.), if a base station configures/indicates dynamic waveform switching for type 2 CG PUSCH through activation DCI (i.e., dynamically indicating waveform according to dynamic waveform switching) before an actual DG PUSCH transmission time, a UE may ignore the waveform configured through the existing higher layer signaling for the waveform of the DG PUSCH and follow (apply) the waveform of the (most recently configured/indicates) type 2 CG PUSCH. Alternatively, if dynamic waveform switching is configured/indicated in DCI that schedules a corresponding DG PUSCH (i.e., dynamically indicating waveform according to dynamic waveform switching), a UE may follow the configured value of the DCI that schedules the corresponding DG PUSCH (i.e., apply a waveform indicated by DCI). On the other hand, if dynamic waveform switching is not configured/indicated in DCI scheduling a corresponding DG PUSCH (i.e., waveform is dynamically indicated according to dynamic waveform switching), a UE may ignore a waveform configured through the existing higher layer signaling for a waveform of a DG PUSCH and follow (i.e., apply) the waveform of the (most recently configured/indicated) type 2 CG PUSCH. In addition, if dynamic waveform switching is not configured/indicated anywhere (i.e., in activation DCI and DCI scheduling a DG PUSCH), a UE may follow (apply) a waveform configured/indicated in higher layer signaling (e.g., SIB, UE specific RRC signaling, etc.) for a DG PUSCH transmission.

### Embodiment 2: Operation Method of UE/Base Station According to Dynamic Waveform Switching Setting

If a new parameter is introduced in higher layer signaling (i.e., SIB, UE specific RRC signaling, etc.) for a CG PUSCH to configure/indicate whether dynamic waveform switching is allowed/supported, and if the new parameter is configured/indicated to allow/support dynamic waveform switching, a UE can directly select a waveform of a CG PUSCH. Here, whether dynamic waveform switching is allowed/supported can also be configured/indicated using an existing parameter in higher layer signaling, and in this case, even if dynamic waveform switching is allowed/supported through the existing parameter, a UE can directly select a waveform of a CG PUSCH.

As an example of the proposed method, if a value (e.g., RSRP value) received/obtained/derived by a UE through a specific reference signal is smaller than a specific threshold value defined in advance (or configured/indicated by a base station), a UE may be configured/defined to transmit a CG PUSCH using waveform A (e.g., DFT-S-OFDM). On the other hand, if a value (e.g., RSRP value) received/obtained/derived by a specific reference signal is greater than or equal to a threshold, a UE may be configured/defined to transmit a CG PUSCH using waveform B (e.g., CP-OFDM). Here, waveform A and B may be interchanged.

In addition, a base station may configure/indicate in advance to use different DMRS (e.g., orthogonal cover code (OCC) index, base sequence index, etc.) for each waveform. In this case, based on the different DMRS configured/indicated by a base station, a UE may use a DMRS allocated to a waveform when transmitting a CG PUSCH using a specific waveform. A base station may detect a DMRS transmitted by a UE to know which waveform the UE used to transmit a CG PUSCH, and may receive the CG PUSCH based on the detected DMRS.

In another proposed method, a waveform for a CG PUSCH can be independently configured depending on whether PUSCH repetition is applied or by a PUSCH repetition number (or repetition range). For example, if the PUSCH repetition is not configured/indicated (i.e., single transmission or repetition number=1), waveform B (e.g., CP-OFDM) can be configured/defined to be used as a PUSCH waveform, and if the PUSCH repetition is configured/indicated (i.e., repetition number >1), waveform A (e.g., DFT-S-OFDM) can be configured/defined to be used as a PUSCH waveform. Here, waveform A and B can be interchanged.

As another example, when a PUSCH repetition number is greater than or equal to K, waveform A (e.g., DFT-S-OFDM) may be configured to be used as a PUSCH waveform, and when a PUSCH repetition number is less than K, waveform B (e.g., CP-OFDM) may be configured to be used as a PUSCH waveform. Here, waveform A and B may be interchanged. The K value may be configured/indicated by a base station through higher layer signaling (e.g., SIB, UE specific RRC signaling, etc.), or may be defined in advance in a standard (e.g., K=8).

Meanwhile, in the method of configuring/indicating a waveform of a CG PUSCH through DCI scheduling a DG PUSCH, if a base station transmits DCI scheduling a DG PUSCH even when a UE does not have UL data to actually transmit, there is a problem that the UE must transmit a PUSCH according to the DCI. Therefore, for this case, a base station may configure/indicate that it does not need to transmit the scheduled DG PUSCH through the DCI (when a UE does not have UL data to transmit) through a specific bit field (or a combination of specific bit field values). In other words, DCI scheduling a DG PUSCH may include an instruction that PUSCH transmission is not needed if there is no UL data transmitted by a UE (or an indication that a UE can ignore DCI). A UE may also be configured/defined to receive a specific bit field combination (or combination of specific bit field values) through DCI and not transmit a PUSCH if there is no UL data to actually transmit. Alternatively, instead of a UE not transmitting a PUSCH, the UE may transmit a known signal/data known to a base station to the base station. Accordingly, the known signal/data may be used for the purpose of notifying a base station that a UE has normally received the corresponding dynamic waveform switching (i.e., a dynamically indicated waveform) (e.g., an ACK (acknowledgement) response).

### Embodiment 3: Method for Configuring Dynamic Waveform Switching in a Multi-Cell (or Multi-TRP) Situation

The above-described dynamic waveform switching may be configured/defined to operate only in single-cell scheduling. However, if dynamic waveform switching is configured/defined to operate also in multi-cell scheduling, the following configuration methods may be required. Here, multi-cell scheduling means a method of simultaneously scheduling multiple PUSCH transmissions on multiple cells through one DCI.

Whether dynamic waveform switching is allowed/supported may vary for each cell. Accordingly, in the first method, if dynamic waveform switching is allowed/supported in a specific cell and dynamic waveform switching is not allowed/supported in another specific cell, a UE can perform dynamic waveform switching according to a value configured/indicated in each cell. That is, even if a UE receives DCI for multi-cell scheduling indicating a specific waveform, the waveform by the multi-cell scheduling DCI can be individually applied to PUSCH transmission depending on whether dynamic waveform switching is allowed/supported in each cell that is a target of multi-cell scheduling.

Alternatively, if dynamic waveform switching is not allowed in one or more specific cells during multi-cell scheduling, dynamic waveform switching may be configured not to be performed in other cells. That is, if dynamic waveform switching is not allowed in one or more specific cells among the cells that are targets of multi-cell scheduling, a UE may not apply a waveform indication of multi-cell scheduling DCI to all PUSCH transmissions on the multi-cell.

Alternatively, if dynamic waveform switching is allowed in one or more specific cells during multi-cell scheduling, dynamic waveform switching may be configured to be performed in other cells as well. That is, if dynamic waveform switching is allowed in one or more specific cells among the cells that are targets of multi-cell scheduling, a UE may apply a waveform indication of multi-cell scheduling DCI to all PUSCH transmissions on the multi-cell.

In multi-cell scheduling DCI, a field for waveform configuration can be individually defined/configured for each cell. Here, a specific field for configuring/indicating dynamic waveform switching (i.e., dynamically indicating a waveform) exists for a specific cell, but a specific field for configuring/indicating dynamic waveform switching (i.e., dynamically indicating a waveform) may not exist for another specific cell. In this case, for a cell where a specific field for configuring/indicating dynamic waveform switching (i.e., dynamically indicating a waveform) does not exist, a UE can be configured to follow (i.e., apply) a waveform configured/indicated through higher layer signaling (e.g., SIB, UE specific RRC signaling, etc.).

Here, multi-cell scheduling DCI may include information (e.g., a cell set indicator) indicating a combination of cells (i.e., multiple cells) that are targets of scheduling. In this case, a cell for which dynamic waveform switching is configured (i.e., allowed/supported) may be included among the multi-cell scheduling target cells. In this case, an operation of UE/base station may be configured by one of the following methods or a combination thereof.

1) Alternative 1: A default waveform for a cell for which dynamic waveform switching is configured/allowed may be predefined/preconfigured between a UE and a base station or defined in the standard. Accordingly, if waveform indication information (e.g., dynamic waveform switching indicator) is not configured in multi-cell scheduling DCI, a default waveform to be used when scheduling a cell for which dynamic waveform switching is configured/allowed through multi-cell scheduling DCI (e.g., cell set indicator in the relevant DCI) may be applied at a time of PUSCH scheduling.

2) Alt 2: If waveform indication information (e.g., dynamic waveform switching indicator) is configured in multi-cell scheduling DCI, the indicated waveform can be applied only to PUSCH transmission on cells with dynamic waveform switching configured (i.e., cells that allow dynamic waveform switching) (e.g., cells indicated by cell set indicator in the corresponding DCI). On the other hand, for cells without dynamic waveform switching configuration (i.e., cells that do not allow dynamic waveform switching), a waveform configured for the corresponding cell through higher layer signaling (e.g., SIB, RRC, etc.) can be used/applied to PUSCH transmission.

3) Alt 3: If waveform indication information (e.g., dynamic waveform switching indicator) is configured in multi-cell scheduling DCI, the indicated waveform can be applied to PUSCH transmission on cells with dynamic waveform switching configurations (i.e., cells that allow dynamic waveform switching) (e.g., cells indicated by the cell set indicator in the DCI). In addition, among cells without dynamic waveform switching configurations (i.e., cells that do not allow dynamic waveform switching), a waveform configured in a corresponding cell through higher layer signaling (e.g., SIB, RRC, etc.) can be applied only to PUSCH transmission on cells that are identical to the waveform indicated by the multi-cell scheduling DCI. In addition, among cells without dynamic waveform switching settings (i.e., among cells that do not allow dynamic waveform switching), it can be considered that there is no PUSCH scheduling for cells where a waveform configured in a corresponding cell through higher layer signaling (e.g., SIB, RRC, etc.) is different from a waveform indicated by multi-cell scheduling DCI.

Alternatively, if a base station considers receiving a PUSCH with multi-TRP, a method in which a UE independently configures a waveform used for PUSCH transmission for each TRP may also be considered. For example, waveforms of different PUSCHs transmitted to two TRPs may be CP-OFDM or DFT-S-OFDM, respectively. Here, a criterion for configuring this may be configured to use DFT-S-OFDM when a UE attempting to transmit a corresponding PUSCH is determined to be far from a specific TRP (e.g., using RSRP, etc.), and to use CP-OFDM otherwise.

### Embodiment 4: Method for Configuring Dynamic Waveform Switching According to Search Space (SS) Type

An operation is being considered to dynamically indicate a waveform for a PUSCH through a field by additionally defining an additional N-bit (e.g., N=1) DCI field for dynamic waveform switching. Here, if an operation is applied to fallback DCI (e.g., DCI format 0_0 with a CRC scrambled by C-RNTI or CS-RNTI or MCS-C-RNTI), whether dynamic waveform switching is supported can be configured differently depending on a search space type. That is, depending on a search space type monitored by fallback DCI, whether a field for indicating a waveform of a PUSCH in the fallback DCI (or indicating whether to apply transform precoding to a PUSCH) is configured/defined can be determined.

Here, it can be assumed that dynamic waveform switching is allowed/supported by higher layer signaling for a cell scheduled by corresponding DCI. That is, for a cell in which dynamic waveform switching is allowed/supported by higher layer signaling, a waveform to be applied to a PUSCH within DCI may or may not be indicated depending on a search space in which a DCI format is monitored.

For example, to be specific, when DCI format 0_0 is monitored in a UE-specific search space (USS) (or, when a UE monitors the DCI format 0_0 in a USS), dynamic waveform switching can be configured/defined to be supported. Accordingly, in this case, a waveform can be dynamically indicated/defined via an additional N-bit (e.g., N=1) DCI field. That is, when DCI format 0_0 is monitored in a USS, a size of a specific field indicating dynamic waveform switching can be configured/defined as N bits (e.g., N=1).

On the other hand, if DCI format 0_0 is monitored in a common search space (CSS) (or, if a UE monitors DCI format 0_0 in a CSS), dynamic waveform switching may be configured/defined not to be supported. Therefore, in this case, if DCI format 0_0 is monitored in a CSS, a size of a specific field indicating dynamic waveform switching (i.e., indicating a waveform to be applied to the PUSCH) may be configured/defined to be 0 bits or a specific field indicating dynamic waveform switching (i.e., indicating a waveform to be applied to a PUSCH) may be configured/defined not to exist.

The proposed method may be set/applied to other UL signals/channels such as a MSG3 PUSCH, a MSGA preamble/PUSCH, and/or a PUSCH/PUCCH.

In addition, it is obvious that the examples of the proposed method described above can also be included as one of the implementation methods of the present disclosure, and thus can be considered as a kind of proposed method. In addition, the proposed methods described above can be implemented independently, but can also be implemented in the form of a combination (or merge) of some proposed methods. The information on whether the proposed methods are applied (or the information on the rules of the proposed methods) can be notified by a base station to a UE through a predefined signal (e.g., a physical layer signal or a higher layer signal), or a rule can be defined to notify. In addition, the higher layer in the present disclosure can include one or more of functional layers, such as MAC, RLC (Radio Link Control), PDCP (Packet Data Convegence Protocol), RRC, and SDAP (Service Data Adaption Protocol).

The methods, embodiments or descriptions for implementing the method proposed in the present disclosure may be applied separately, or one or more methods (or embodiments or descriptions) may be applied in combination.

FIG. 8 is a diagram illustrating a signaling method for a PUSCH transmission and reception method according to an embodiment of the present disclosure.

FIG. 8 illustrates signaling between a base station (e.g., TRP 1, TRP 2) and a UE to which the methods proposed in the present disclosure can be applied. Here, the UE/base station is only an example, and various devices can be applied instead. FIG. 8 is only for convenience of explanation and does not limit the scope of the present disclosure. In addition, some of the steps illustrated in FIG. 8 may be omitted depending on the situation and/or settings.

Referring to FIG. 8, a UE receives configuration information related to a PUSCH from a base station (S801).

Here, the configuration information related to a PUSCH (e.g., PUSCH configuration (PUSCH-Config)) (hereinafter, first configuration information) may include information (hereinafter, first information) on whether dynamic waveform switching for PUSCH is supported/allowed. In other words, the first information may be information indicating/configuring whether dynamic waveform switching for PUSCH transmission is enabled or disabled. Alternatively, the first information may be information indicating/configuring whether transform precoding for PUSCH transmission is dynamically changed/configured. In addition, the first configuration information may include information indicating whether transform precoding is applied (i.e., enabled) or not applied (i.e., disabled) to the PUSCH transmission.

The first configuration information can be transmitted through higher layer signaling (e.g., SIB, RRC signaling, etc.).

For example, according to the above-described embodiment 1, although not shown in FIG. 8, a UE may further receive second configuration information related to a CG PUSCH from a base station. In this case, the second configuration information may include information on whether dynamic waveform switching for a CG PUSCH is supported (e.g., via a newly defined parameter or using an existing parameter). In addition, based on a support of dynamic waveform switching for a CG PUSCH, the second configuration information may include a set of parameter(s) for individual CG PUSCH transmissions according to a waveform for a CG PUSCH (i.e., depending on whether transform precoding is applied or not applied). In addition, the second configuration information may also include information indicating whether transform precoding is applied (i.e., enabled) or not applied (i.e., disabled) to the CG PUSCH transmission.

In addition, according to the above-described embodiment 3, multiple PUSCHs transmitted in multiple cells can be scheduled by a single multi-cell scheduling DCI. In this case, information on whether dynamic waveform switching for the PUSCH is supported/allowed can be individually set for each cell. For example, the first configuration information can be configured for each cell, and the first information in one first configuration information can be configured for each cell.

A UE receives downlink control information for scheduling a PUSCH from a base station (S802).

Here, according to the embodiments described above, the downlink control information may include information (hereinafter, second information) for indicating whether transform precoding for the PUSCH is enabled or disabled, as indicated by the first information that dynamic waveform switching is allowed/supported (e.g., dynamic waveform switching is enabled).

Here, the second information may be information for indicating/configuring whether a waveform for PUSCH transmission is CP-OFDM or DFT-S-OFDM. In other words, the second information may be information for indicating/configuring whether transform precoding for PUSCH transmission is enabled or disabled (i.e., whether transform precoding is applied or not applied).

Additionally, a 1-bit field (e.g., a dynamic waveform switching indication field) for indicating whether the transform precoding is enabled or disabled may be included in the downlink control information. That is, the second information may be provided to a UE via the 1-bit field (e.g., a dynamic waveform switching indication field).

For example, according to the above-described embodiment 1, even if the DCI including the second information is received before transmission of the CG PUSCH according to the second configuration information, whether to apply the transform precoding to the CG PUSCH may be determined according to information indicating whether to enable or disable transform precoding by higher layer signaling (e.g., the second configuration information or SIB). Alternatively, if the DCI including the second information is received before transmission of the CG PUSCH according to the second configuration information, whether to apply the transform precoding to the CG PUSCH may be determined according to the second information. Here, whether to apply the transform precoding may be determined based on the second information only for the CG PUSCH that is configured to be transmitted within a predetermined time interval (e.g., N ms, N slots, N symbols) from a time at which the DCI is received or a time at which the PUSCH is transmitted by the DCI.

In addition, according to the above-described embodiment 3, the DCI may be DCI scheduling multiple PUSCHs for multiple cells. In this case, the DCI may include the second information for the multiple PUSCHs or for each of the multiple PUSCHs.

In addition, according to the above-described embodiment 4, based on a type of a search space in which the DCI is monitored as the dynamic waveform switching is supported, it may be determined whether the DCI includes second information indicating whether transform precoding for the PUSCH is enabled or disabled. For example, based on the DCI being monitored in a USS, the DCI may include the second information, and whether the transform precoding is applied to the PUSCH may be determined based on the second information. Additionally, for example, based on the DCI being monitored in a CSS, the DCI may not include the second information, and whether to apply the transform precoding to the PUSCH may be determined based on information indicating whether transform precoding is enabled or disabled by higher layer signaling (e.g., the first configuration information or SIB).

A UE transmits a PUSCH to a base station (S803).

Here, based on the downlink control information including the second information (e.g., a 1-bit dynamic waveform switching indication field), whether to apply transform precoding to uplink transmission can be determined according to the second information (i.e., a waveform for uplink transmission can be determined).

Here, even if transform precoding for a PUSCH is enabled or disabled by higher layer signaling (e.g., first configuration information or SIB), if the downlink control information includes the second information (e.g., 1-bit dynamic waveform switching indication field), the enabled or disabled indication value for transform precoding by higher layer signaling may be ignored. That is, a UE may prioritize the second information (e.g., 1-bit dynamic waveform switching indication field) in the control information (e.g., DCI, MAC CE) over higher layer signaling. For example, according to the embodiment 4 described above, the DCI may include the second information based on the DCI being monitored in a USS.

In addition, whether to apply the transform precoding to the PUSCH may be determined (i.e., a waveform for uplink transmission may be determined) based on higher layer signaling (e.g., first configuration information or SIB) based on the downlink control information not including the second information (e.g., a 1-bit dynamic waveform switching indication field). For example, according to the embodiment 4 described above, the DCI may not include the second information based on the DCI being monitored in a CSS.

In addition, according to the above-described embodiment 3, whether to apply the transform precoding to the PUSCH can be individually determined for each cell of the multiple cells scheduled by the DCI. For example, whether to allow/support dynamic waveform switching can be individually configured for multiple cells by the first configuration information, and whether to apply the transform precoding (i.e., enabled or disabled) can be individually configured for multiple cells. In this case, even if an application of the transform precoding (i.e., enabled or disabled) to multiple PUSCHs on multiple cells (or for each PUSCH) is indicated by the DCI, an application of transform precoding (i.e., enabled or disabled) can be determined for each cell by the first configuration information (i.e., for a cell where dynamic waveform switching is not allowed) or by the DCI (i.e., for a cell where dynamic waveform switching is allowed).

In addition, according to the above-described embodiment 1, based on the DCI including the second information being received before transmission of the CG PUSCH according to the second configuration information, whether to apply transform precoding (i.e., enabled or disabled) to the CG PUSCH may be determined according to the second information, or may be determined according to higher layer signaling (e.g., the second configuration information or SIB).

In addition, according to the above-described embodiment 2, if dynamic waveform switching for the CG PUSCH is supported according to the second configuration information, whether to apply the transform precoding may be determined based on whether or not a CG PUSCH is repeatedly transmitted or a repetition number based on a value (e.g., RSRP) received/acquired through a specific reference signal for a CG PUSCH.

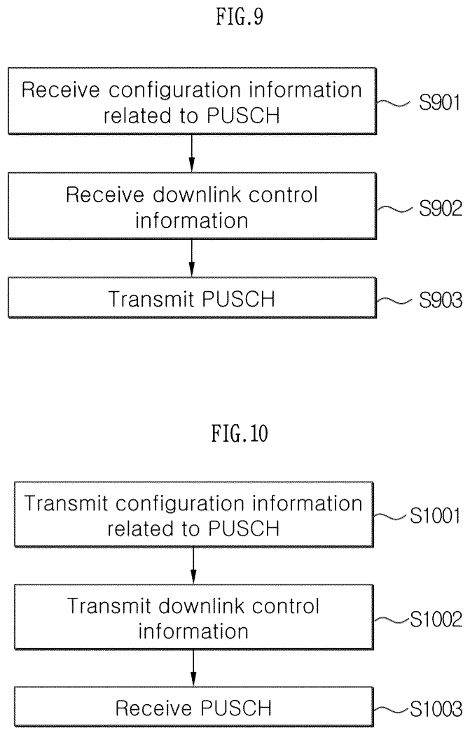

FIG. 9 is a diagram illustrating an operation of a UE for a PUSCH transmission and reception method according to an embodiment of the present disclosure.

FIG. 9 illustrates an operation of a UE based on the proposed methods. The example of FIG. 9 is provided for convenience of explanation and does not limit the scope of the present disclosure. Some step(s) illustrated in FIG. 9 may be omitted depending on circumstances and/or settings. In addition, the UE in FIG. 9 is only an example and may be implemented as a device illustrated in FIG. 11 below. For example, the processor (102/202) of FIG. 11 may control the transceiver (106/206) to transmit and receive channels/signals/data/information, etc., and may also control the processor (102/202) of FIG. 11 to store transmitted or received channels/signals/data/information, etc. in the memory (104/204).

In addition, the operation of FIG. 9 may be processed by one or more processors (102, 202) of FIG. 11, and the operation of FIG. 9 may be stored in a memory (e.g., one or more memories (104, 204) of FIG. 11) in the form of a command/program (e.g., an instruction, an executable code) for driving at least one processor (e.g., 102, 202) of FIG. 11.

Referring to FIG. 9, a UE receives configuration information related to a PUSCH from a base station (S901).

Here, the configuration information related to a PUSCH (e.g., PUSCH configuration (PUSCH-Config)) (hereinafter, first configuration information) may include information (hereinafter, first information) on whether dynamic waveform switching for PUSCH is supported/allowed. In other words, the first information may be information indicating/configuring whether dynamic waveform switching for PUSCH transmission is enabled or disabled. Alternatively, the first information may be information indicating/configuring whether transform precoding for PUSCH transmission is dynamically changed/configured. In addition, the first configuration information may include information indicating whether transform precoding is applied (i.e., enabled) or not applied (i.e., disabled) to the PUSCH transmission.

The first configuration information can be transmitted through higher layer signaling (e.g., SIB, RRC signaling, etc.).

For example, according to the above-described embodiment 1, although not shown in FIG. 9, a UE may further receive second configuration information related to a CG PUSCH from a base station. In this case, the second configuration information may include information on whether dynamic waveform switching for a CG PUSCH is supported (e.g., via a newly defined parameter or using an existing parameter). In addition, based on a support of dynamic waveform switching for a CG PUSCH, the second configuration information may include a set of parameter(s) for individual CG PUSCH transmissions according to a waveform for a CG PUSCH (i.e., depending on whether transform precoding is applied or not applied). In addition, the second configuration information may also include information indicating whether transform precoding is applied (i.e., enabled) or not applied (i.e., disabled) to the CG PUSCH transmission.

In addition, according to the above-described embodiment 3, multiple PUSCHs transmitted in multiple cells can be scheduled by a single multi-cell scheduling DCI. In this case, information on whether dynamic waveform switching for the PUSCH is supported/allowed can be individually set for each cell. For example, the first configuration information can be configured for each cell, and the first information in one first configuration information can be configured for each cell.

A UE receives downlink control information for scheduling a PUSCH from a base station (S902).

Here, according to the embodiments described above, the downlink control information may include information (hereinafter, second information) for indicating whether transform precoding for the PUSCH is enabled or disabled, as indicated by the first information that dynamic waveform switching is allowed/supported (e.g., dynamic waveform switching is enabled).

Here, the second information may be information for indicating/configuring whether a waveform for PUSCH transmission is CP-OFDM or DFT-S-OFDM. In other words, the second information may be information for indicating/configuring whether transform precoding for PUSCH transmission is enabled or disabled (i.e., whether transform precoding is applied or not applied).

Additionally, a 1-bit field (e.g., a dynamic waveform switching indication field) for indicating whether the transform precoding is enabled or disabled may be included in the downlink control information. That is, the second information may be provided to a UE via the 1-bit field (e.g., a dynamic waveform switching indication field).

For example, according to the above-described embodiment 1, even if the DCI including the second information is received before transmission of the CG PUSCH according to the second configuration information, whether to apply the transform precoding to the CG PUSCH may be determined according to information indicating whether to enable or disable transform precoding by higher layer signaling (e.g., the second configuration information or SIB). Alternatively, if the DCI including the second information is received before transmission of the CG PUSCH according to the second configuration information, whether to apply the transform precoding to the CG PUSCH may be determined according to the second information. Here, whether to apply the transform precoding may be determined based on the second information only for the CG PUSCH that is configured to be transmitted within a predetermined time interval (e.g., N ms, N slots, N symbols) from a time at which the DCI is received or a time at which the PUSCH is transmitted by the DCI.

In addition, according to the above-described embodiment 3, the DCI may be DCI scheduling multiple PUSCHs for multiple cells. In this case, the DCI may include the second information for the multiple PUSCHs or for each of the multiple PUSCHs.

In addition, according to the above-described embodiment 4, based on a type of a search space in which the DCI is monitored as the dynamic waveform switching is supported, it may be determined whether the DCI includes second information indicating whether transform precoding for the PUSCH is enabled or disabled. For example, based on the DCI being monitored in a USS, the DCI may include the second information, and whether the transform precoding is applied to the PUSCH may be determined based on the second information. Additionally, for example, based on the DCI being monitored in a CSS, the DCI may not include the second information, and whether to apply the transform precoding to the PUSCH may be determined based on information indicating whether transform precoding is enabled or disabled by higher layer signaling (e.g., the first configuration information or SIB).

A UE transmits a PUSCH to a base station (S903).

Here, based on the downlink control information including the second information (e.g., a 1-bit dynamic waveform switching indication field), whether to apply transform precoding to uplink transmission can be determined according to the second information (i.e., a waveform for uplink transmission can be determined).

Here, even if transform precoding for a PUSCH is enabled or disabled by higher layer signaling (e.g., first configuration information or SIB), if the downlink control information includes the second information (e.g., 1-bit dynamic waveform switching indication field), the enabled or disabled indication value for transform precoding by higher layer signaling may be ignored. That is, a UE may prioritize the second information (e.g., 1-bit dynamic waveform switching indication field) in the control information (e.g., DCI, MAC CE) over higher layer signaling. For example, according to the embodiment 4 described above, the DCI may include the second information based on the DCI being monitored in a USS.

In addition, whether to apply the transform precoding to the PUSCH may be determined (i.e., a waveform for uplink transmission may be determined) based on higher layer signaling (e.g., first configuration information or SIB) based on the downlink control information not including the second information (e.g., a 1-bit dynamic waveform switching indication field). For example, according to the embodiment 4 described above, the DCI may not include the second information based on the DCI being monitored in a CSS.

In addition, according to the above-described embodiment 3, whether to apply the transform precoding to the PUSCH can be individually determined for each cell of the multiple cells scheduled by the DCI. For example, whether to allow/support dynamic waveform switching can be individually configured for multiple cells by the first configuration information, and whether to apply the transform precoding (i.e., enabled or disabled) can be individually configured for multiple cells. In this case, even if an application of the transform precoding (i.e., enabled or disabled) to multiple PUSCHs on multiple cells (or for each PUSCH) is indicated by the DCI, an application of transform precoding (i.e., enabled or disabled) can be determined for each cell by the first configuration information (i.e., for a cell where dynamic waveform switching is not allowed) or by the DCI (i.e., for a cell where dynamic waveform switching is allowed).

In addition, according to the above-described embodiment 1, based on the DCI including the second information being received before transmission of the CG PUSCH according to the second configuration information, whether to apply transform precoding (i.e., enabled or disabled) to the CG PUSCH may be determined according to the second information, or may be determined according to higher layer signaling (e.g., the second configuration information or SIB).

In addition, according to the above-described embodiment 2, if dynamic waveform switching for the CG PUSCH is supported according to the second configuration information, whether to apply the transform precoding may be determined based on whether or not a CG PUSCH is repeatedly transmitted or a repetition number based on a value (e.g., RSRP) received/acquired through a specific reference signal for a CG PUSCH.

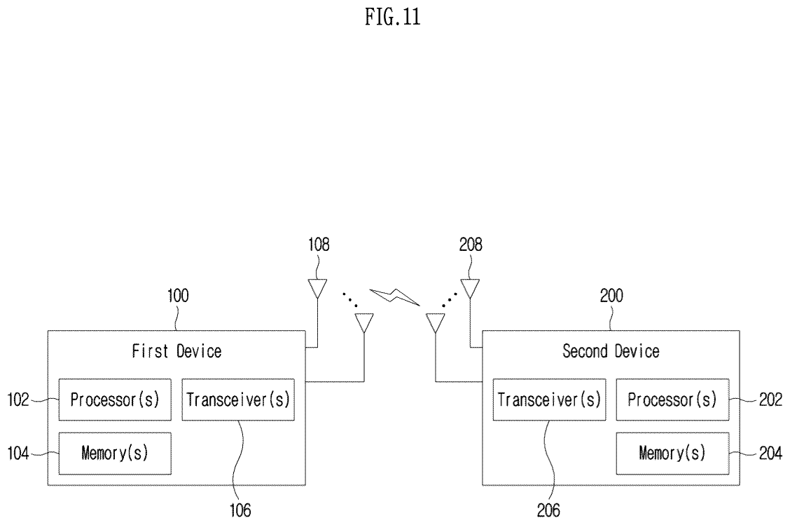

FIG. 10 is a diagram illustrating an operation of a base station for a PUSCH transmission and reception method according to an embodiment of the present disclosure.

FIG. 10 illustrates an operation of a base station based on the proposed methods. The example of FIG. 10 is provided for convenience of explanation and does not limit the scope of the present disclosure. Some step(s) illustrated in FIG. 10 may be omitted depending on circumstances and/or settings. In addition, the base station in FIG. 10 is only an example and may be implemented as a device illustrated in FIG. 11 below. For example, the processor (102/202) of FIG. 11 may control the transceiver (106/206) to transmit and receive channels/signals/data/information, etc., and may also control the processor (102/202) of FIG. 11 to store transmitted or received channels/signals/data/information, etc. in the memory (104/204).

In addition, the operation of FIG. 10 may be processed by one or more processors (102, 202) of FIG. 11, and the operation of FIG. 10 may be stored in a memory (e.g., one or more memories (104, 204) of FIG. 11) in the form of a command/program (e.g., an instruction, an executable code) for driving at least one processor (e.g., 102, 202) of FIG. 11.

Referring to FIG. 10, a base station transmits configuration information related to a PUSCH to a UE (S1001).

Here, the configuration information related to a PUSCH (e.g., PUSCH configuration (PUSCH-Config)) (hereinafter, first configuration information) may include information (hereinafter, first information) on whether dynamic waveform switching for PUSCH is supported/allowed. In other words, the first information may be information indicating/configuring whether dynamic waveform switching for PUSCH transmission is enabled or disabled. Alternatively, the first information may be information indicating/configuring whether transform precoding for PUSCH transmission is dynamically changed/configured. In addition, the first configuration information may include information indicating whether transform precoding is applied (i.e., enabled) or not applied (i.e., disabled) to the PUSCH transmission.

The first configuration information can be transmitted through higher layer signaling (e.g., SIB, RRC signaling, etc.).

For example, according to the above-described embodiment 1, although not shown in FIG. 10, a base station may further transmit second configuration information related to a CG PUSCH to a UE. In this case, the second configuration information may include information on whether dynamic waveform switching for a CG PUSCH is supported (e.g., via a newly defined parameter or using an existing parameter). In addition, based on a support of dynamic waveform switching for a CG PUSCH, the second configuration information may include a set of parameter(s) for individual CG PUSCH transmissions according to a waveform for a CG PUSCH (i.e., depending on whether transform precoding is applied or not applied). In addition, the second configuration information may also include information indicating whether transform precoding is applied (i.e., enabled) or not applied (i.e., disabled) to the CG PUSCH transmission.

In addition, according to the above-described embodiment 3, multiple PUSCHs transmitted in multiple cells can be scheduled by a single multi-cell scheduling DCI. In this case, information on whether dynamic waveform switching for the PUSCH is supported/allowed can be individually set for each cell. For example, the first configuration information can be configured for each cell, and the first information in one first configuration information can be configured for each cell.

A base station transmits downlink control information for scheduling a PUSCH to a UE (S1002).

Here, according to the embodiments described above, the downlink control information may include information (hereinafter, second information) for indicating whether transform precoding for the PUSCH is enabled or disabled, as indicated by the first information that dynamic waveform switching is allowed/supported (e.g., dynamic waveform switching is enabled).

Here, the second information may be information for indicating/configuring whether a waveform for PUSCH transmission is CP-OFDM or DFT-S-OFDM. In other words, the second information may be information for indicating/configuring whether transform precoding for PUSCH transmission is enabled or disabled (i.e., whether transform precoding is applied or not applied).

Additionally, a 1-bit field (e.g., a dynamic waveform switching indication field) for indicating whether the transform precoding is enabled or disabled may be included in the downlink control information. That is, the second information may be provided to a UE via the 1-bit field (e.g., a dynamic waveform switching indication field).

For example, according to the above-described embodiment 1, even if the DCI including the second information is received before transmission of the CG PUSCH according to the second configuration information, whether to apply the transform precoding to the CG PUSCH may be determined according to information indicating whether to enable or disable transform precoding by higher layer signaling (e.g., the second configuration information or SIB). Alternatively, if the DCI including the second information is received before transmission of the CG PUSCH according to the second configuration information, whether to apply the transform precoding to the CG PUSCH may be determined according to the second information. Here, whether to apply the transform precoding may be determined based on the second information only for the CG PUSCH that is configured to be transmitted within a predetermined time interval (e.g., N ms, N slots, N symbols) from a time at which the DCI is received or a time at which the PUSCH is transmitted by the DCI.

In addition, according to the above-described embodiment 3, the DCI may be DCI scheduling multiple PUSCHs for multiple cells. In this case, the DCI may include the second information for the multiple PUSCHs or for each of the multiple PUSCHs.

In addition, according to the above-described embodiment 4, based on a type of a search space in which the DCI is monitored as the dynamic waveform switching is supported, it may be determined whether the DCI includes second information indicating whether transform precoding for the PUSCH is enabled or disabled. For example, based on the DCI being monitored in a USS, the DCI may include the second information, and whether the transform precoding is applied to the PUSCH may be determined based on the second information. Additionally, for example, based on the DCI being monitored in a CSS, the DCI may not include the second information, and whether to apply the transform precoding to the PUSCH may be determined based on information indicating whether transform precoding is enabled or disabled by higher layer signaling (e.g., the first configuration information or SIB).

A base station receives a PUSCH from a UE (S1003).

Here, based on the downlink control information including the second information (e.g., a 1-bit dynamic waveform switching indication field), whether to apply transform precoding to uplink transmission can be determined according to the second information (i.e., a waveform for uplink transmission can be determined).

Here, even if transform precoding for a PUSCH is enabled or disabled by higher layer signaling (e.g., first configuration information or SIB), if the downlink control information includes the second information (e.g., 1-bit dynamic waveform switching indication field), the enabled or disabled indication value for transform precoding by higher layer signaling may be ignored. That is, a UE may prioritize the second information (e.g., 1-bit dynamic waveform switching indication field) in the control information (e.g., DCI, MAC CE) over higher layer signaling. For example, according to the embodiment 4 described above, the DCI may include the second information based on the DCI being monitored in a USS.

In addition, whether to apply the transform precoding to the PUSCH may be determined (i.e., a waveform for uplink transmission may be determined) based on higher layer signaling (e.g., first configuration information or SIB) based on the downlink control information not including the second information (e.g., a 1-bit dynamic waveform switching indication field). For example, according to the embodiment 4 described above, the DCI may not include the second information based on the DCI being monitored in a CSS.

In addition, according to the above-described embodiment 3, whether to apply the transform precoding to the PUSCH can be individually determined for each cell of the multiple cells scheduled by the DCI. For example, whether to allow/support dynamic waveform switching can be individually configured for multiple cells by the first configuration information, and whether to apply the transform precoding (i.e., enabled or disabled) can be individually configured for multiple cells. In this case, even if an application of the transform precoding (i.e., enabled or disabled) to multiple PUSCHs on multiple cells (or for each PUSCH) is indicated by the DCI, an application of transform precoding (i.e., enabled or disabled) can be determined for each cell by the first configuration information (i.e., for a cell where dynamic waveform switching is not allowed) or by the DCI (i.e., for a cell where dynamic waveform switching is allowed).

In addition, according to the above-described embodiment 1, based on the DCI including the second information being received before transmission of the CG PUSCH according to the second configuration information, whether to apply transform precoding (i.e., enabled or disabled) to the CG PUSCH may be determined according to the second information, or may be determined according to higher layer signaling (e.g., the second configuration information or SIB).

In addition, according to the above-described embodiment 2, if dynamic waveform switching for the CG PUSCH is supported according to the second configuration information, whether to apply the transform precoding may be determined based on whether or not a CG PUSCH is repeatedly transmitted or a repetition number based on a value (e.g., RSRP) received/acquired through a specific reference signal for a CG PUSCH.

General Device to which the Present Disclosure May be Applied

FIG. 11 is a diagram which illustrates a block diagram of a wireless communication device according to an embodiment of the present disclosure.

In reference to FIG. 11, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc.

For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

1. A method performed by a user equipment (UE) in a wireless communication system, the method comprising:
receiving first configuration information related to a physical uplink shared channel (PUSCH) from a base station, wherein the first configuration information includes first information on whether dynamic waveform switching for the PUSCH is supported;
receiving downlink control information (DCI) scheduling the PUSCH from the base station; and
transmitting the PUSCH to the base station,
wherein based on that the dynamic waveform switching is supported, whether the DCI includes second information indicating that transform precoding for the PUSCH is enabled or disabled is determined based on a type of a search space in which the DCI is monitored.

2. The method of claim 1, wherein the DCI includes the second information based on the DCI being monitored in a UE-specific search space (USS), and
wherein whether to apply the transform precoding to the PUSCH is determined according to the second information.

3. The method of claim 1, wherein the DCI does not include the second information based on the DCI being monitored in a common search space (CSS), and
wherein whether to apply the transform precoding to the PUSCH is determined according to information indicating whether transform precoding is enabled or disabled by higher layer signaling.

4. The method of claim 2, further comprising:
receiving second configuration information for a configured grant (CG) PUSCH.

5. The method of claim 4, wherein even if the DCI including the second information is received before transmission of the CG PUSCH, whether to apply the transform precoding to the CG PUSCH is determined according to information indicating whether transform precoding is enabled or disabled by higher layer signaling.

6. The method of claim 4, wherein based on the DCI including the second information being received before transmission of the CG PUSCH, whether to apply the transform precoding to the CG PUSCH is determined according to the second information.

7. The method of claim 6, wherein whether to apply the transform precoding is determined according to the second information only for the CG PUSCH that is configured to be transmitted within a predetermined time duration from a time at which the DCI is received or a time at which the PUSCH is transmitted by the DCI.

8. The method of claim 4, wherein the second configuration information includes information on whether dynamic waveform switching is supported for the CG PUSCH.

9. The method of claim 8, wherein based on support of dynamic waveform switching for the CG PUSCH according to the second configuration information, the second configuration information includes an individual parameter set according to whether the transform precoding is applied to the CG PUSCH.

10. The method of claim 1, wherein the DCI schedules multiple PUSCHs for multiple cells, and
wherein whether dynamic waveform switching is supported for the multiple cells is individually configured.

11. A user equipment (UE) operating in a wireless communication system, the UE comprising:
at least one transceiver for transmitting and receiving a wireless signal; and
at least one processor for controlling the at least one transceiver,
wherein the at least one processor configured to:
receive first configuration information related to a physical uplink shared channel (PUSCH) from a base station, wherein the first configuration information includes first information on whether dynamic waveform switching for the PUSCH is supported;
receive downlink control information (DCI) scheduling the PUSCH from the base station; and
transmit the PUSCH to the base station,
wherein based on that the dynamic waveform switching is supported, whether the DCI includes second information indicating that transform precoding for the PUSCH is enabled or disabled is determined based on a type of a search space in which the DCI is monitored.

12-14. (canceled)

15. A base station operating in a wireless communication system, the base station comprising:
at least one transceiver for transmitting and receiving a wireless signal; and
at least one processor for controlling the at least one transceiver,
wherein the at least one processor configured to:
transmit first configuration information related to a physical uplink shared channel (PUSCH) to a user equipment (UE), wherein the first configuration information includes first information on whether dynamic waveform switching for the PUSCH is supported;
transmit downlink control information (DCI) scheduling the PUSCH to the UE; and
receive the PUSCH from the UE,
wherein based on that the dynamic waveform switching is supported, whether the DCI includes second information indicating that transform precoding for the PUSCH is enabled or disabled is determined based on a type of a search space in which the DCI is monitored.
